(19) United States
(12) Patent Application Publication
(10) Pub. No.: US 2024/0308818 A1
(43) Pub. Date: Sep. 19, 2024

(54) MOBILE CRANE OUTRIGGER COMPRISING A FIXING DEVICE

(71) Applicant: MANITOWOC CRANE GROUP FRANCE SAS, Dardilly (FR)

(72) Inventor: Dieter STÜHRWOLDT, WILHELMSHAVEN (DE)

(21) Appl. No.: 18/604,818

(22) Filed: Mar. 14, 2024

(30) Foreign Application Priority Data
Mar. 15, 2023 (EP) 23161955.2

(51) Int. Cl. B66C 23/80

(52) U.S. Cl. CPC B66C 23/80

(57) ABSTRACT

A mobile crane supporting device includes a first support segment; a second support segment; and a fixing device having contact portions which are respectively assigned to the first support segment and the second support segment and which can be moved into abutment with each other in order to prevent a travelling movement in any relative position between the first support segment and the second support segment, wherein the second support segment can rotate within and relative to the first support segment about an axis extending in the horizontal direction and transversely with respect to the travelling movement and can thus selectively move the contact portions into abutment with each other or separate them from each other. A mobile crane may include such a supporting device.

### FIELD

The present disclosure relates to a mobile crane supporting device in which any relative position between two support segments which can be moved relative to each other is defined by means of a fixing device.

### BACKGROUND

In order to provide mobile cranes with sufficient tilting stability during crane operations, their undercarriage comprises an outrigger comprising usually four supporting members which can be extended in the transverse direction with respect to the longitudinal axis of the undercarriage and/or pivoted. At their ends facing away from the undercarriage, the supporting members each comprise a supporting cylinder which can be extended in the vertical direction and which is supported on the ground by means of a supporting disc. Usually, two supporting members which can be extended in mutually opposite directions are arranged in each of the front and rear regions of the undercarriage. Deformations and load changes during crane operations cause longitudinal forces in the supporting members which can shift the supporting members. An unintended longitudinal movement of the supporting members is usually prevented by mechanically bolting the supporting members. For structural reasons, however, the number of possible bolting positions is limited.

Modern-design cranes comprise a load torque limiter which in principle allows any positions of the supporting members to be approached, which simplifies or even only then enables crane operations in difficult spaces, wherein it is not however possible to mechanically bolt and thus reliably define the position of the supporting members in all positions of the supporting members, for the aforementioned reasons, thus requiring the current position of the supporting members to be continuously monitored and certain crane functions to be disabled if a supporting member has left its target position, in order to safely operate the crane. DE 10 2020 212 687 proposes defining the position of the supporting members by means of a brake rail and a brake engaging element which engages the brake rail.

### SUMMARY

It is the object of the present disclosure to provide an improved way, as compared to previous solutions, of reliably defining the position of supporting members for crane operations.

The mobile crane supporting device in accordance with the present disclosure comprises a first support segment which can be fastened to the undercarriage of the mobile crane, a second support segment which can be moved within and relative to the first support segment and which comprises a support foot which can be moved in the vertical direction, and a fixing device comprising contact portions which are respectively assigned to the first support segment and the second support segment and which can be moved into abutment with each other in order to prevent a travelling movement of the first support segment in any relative position between the first support segment and the second support segment. In accordance with the present disclosure, the second support segment can rotate within and relative to the first support segment about an axis extending in the horizontal direction and transversely with respect to the travelling movement and can thus selectively move the contact portions into abutment with each other or separate them from each other.

The first support segment can then be formed by a so-called supporting box which permanently or detachably assumes a fixed position on the crane undercarriage. The first support segment can however equally be formed by a supporting member which can be translationally moved or rotationally pivoted relative to the crane undercarriage and/or a supporting box. The supporting device in accordance with the present disclosure can accordingly be constructed from any number of support segments which can be rotationally or translationally moved relative to each other and/or relative to the crane undercarriage, and the translational travelling movements of which can be prevented by a fixing device in accordance with the present disclosure.

In accordance with the present disclosure, it is not only possible for the second support segment to move translationally relative to the first support segment, i.e. to extend and retract again. It is instead also possible for it to pivot or tilt within the first support segment, about a horizontal axis which extends transversely and in particular perpendicularly with respect to the directions in which the second support segment is extended out of the first support segment and retracted again. As will be explained in more detail further below, this rotational movement is caused by actuating the supporting cylinder at the free end of the second support segment, since dissipating the forces, caused by the weight of the crane, into the ground via the crane outrigger results in a transverse force load on the support segments, due to which the end portions of the support segments abut against the other support segment in each case. The present disclosure uses this effect and the forces acting between the contact portions of the respective support segments to effectively prevent a travelling movement of the second support segment relative to the first support segment. When the supporting cylinder is retracted, the transverse force load on the support segments and consequently also the forces acting in the contact portions between the support segments are cancelled, which once more enables a travelling movement of the second support segment within the first support segment.

In the present supporting device, the relative position between the two support segments is thus defined as a function of the vertical load on the supporting device due to the weight of the crane, without this requiring a separate actuator.

In accordance with one embodiment, the end region of the first support segment facing the support foot comprises
a lower support bearing which in particular comprises at least one rolling element and via which the second support segment can be supported on the first support segment while moving, and/or
an upper support bearing which in particular comprises at least one pressing element and via which the second support segment can be supported on the first support segment while rotating.

The support bearings on the first support segment as described above define the positions at which the support segments contact each other in the individual load states of the supporting device. Since a translational relative movement occurs between the mutually contacting support segments in the region of the support bearing which is arranged below the second support segment, it is then advantageous to provide one or more suitable rolling elements or at least friction-reducing sliding elements in order to avoid wear in this region. When the mobile crane is supported, the support bearing which is arranged above the second support segment serves as a fulcrum, so to speak, and should provide a correspondingly large bearing surface for the second support segment in order to avoid excessive material stress. The position of this support bearing, together with the length of the portion of the second support segment left in the first support segment, crucially affects the forces acting in the contact portions and consequently also therefore the capacity, provided by the corresponding contact portions, to define the position of the second support segment relative to the first support segment.

In accordance with another embodiment
the end region of the second support segment facing away from the support foot comprises an upper support bearing which in particular comprises at least one pressing element and via which the second support segment can be supported on the first support segment while moving, and/or
the second support segment is embodied such that its center of gravity is always arranged beyond the lower support bearing of the first support segment and in particular outside the first support segment.

The support bearing described above serves to reduce friction and wear when the second support segment is moving within the first support segment and can, like the support bearing arranged below the second support segment between the first support segment and the second support segment, comprise one or more rolling elements or at least friction-reducing and therefore wear-reducing sliding elements.

It is also advantageous for the center of gravity of the second support segment to always, i.e. in all relative positions, be situated on the side, facing away from the crane undercarriage, of the support bearing which is arranged below the second support segment, whereby the portion of the second support segment located within the first support segment is automatically raised, so to speak, when the supporting device is not exposed to a load, and the respective contact portions are thus separated from each other.

In another embodiment, the respective contact portions are arranged on an inner wall of the first support segment and an outer wall of the second support segment. It is however equally conceivable for at least one of the contact portions to not be arranged directly on the support segment to which it is assigned, but rather only indirectly via one or more structures which are located between the contact portion and the support segment and transmit the occurrent forces between the contact portion and the support segment.

It is in principle conceivable for the contact portions, which are moved into abutment by exposing the supporting device to a load, to fix the two support segments with respect to each other in a frictional fit. It is however equally possible for the respective contact portions to interlock in a positive fit, wherein at least one of the contact portions in particular exhibits a toothed profile or an equivalent profile suitable for establishing a positive fit between the contact portions.

In another embodiment, the fixing device comprises a release device which is biased as soon as the contact portions are moved into abutment with each other and which, when biased, is inclined to separate the contact portions from each other again, wherein the release device in particular comprises an elastic spring. As an alternative to or in addition to the second support segment having a center of gravity situated outside the first support segment, such a release device serves to enable the second support segment to move when the supporting device is not exposed to a load. The release device can for example comprise a bearing element which contacts the inner wall of the first support segment and/or its contact portion in order to introduce the biasing force, generated by a biasing element such as for example an elastic spring, into the first support segment, wherein the bearing element can be partially or entirely made from a friction-reducing material in order to avoid wear.

In accordance with another embodiment, the travelling movement of the second support segment relative to the first support segment is generated by a hydraulic cylinder. Any suitable drive, such as mechanical drives comprising a gear system, is in principle conceivable for this purpose.

In accordance with another embodiment, the support foot can comprise a hydraulic supporting cylinder which is in turn supported for example on the ground via a supporting disc.

In another embodiment, the first support segment is formed by a supporting box comprising supporting members which are telescopic on both sides of the supporting box and respectively form a second support segment.

Another aspect of the present disclosure relates to a mobile crane comprising a supporting device in accordance with one of the embodiments described above.

### BRIEF DESCRIPTION OF THE DRAWINGS

The present invention is explained in more detail below on the basis of a preferred embodiment and by referring to the enclosed figures. The invention can comprise any of the features disclosed here, individually and in any expedient combination.

There is shown:

FIG. 1 a supporting device in accordance with the invention when not exposed to a load; and

FIG. 2 the supporting device from FIG. 1 when exposed to a load.

### DESCRIPTION

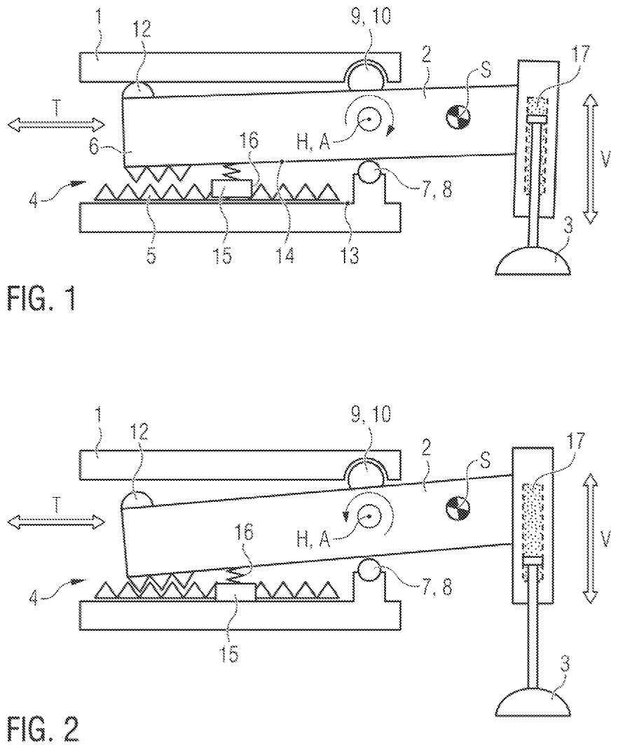

FIG. 1 schematically shows the structure and function of the supporting device in accordance with the present disclosure on the basis of an individual pairing of a first support segment or supporting box 1 and a second support segment or supporting member 2. The supporting member 2 extends within the supporting box 1 and can be extended out of the supporting box 1 to the right and retracted into it again to the left in the horizontal direction T within the supporting box 1 by means of a hydraulic cylinder (not shown). In order to support the mobile crane on both sides, the supporting box 1 also accommodates a second supporting member (not shown) which can be extended out of the supporting box 1 to the left and retracted into it to the right in an identical way to the first supporting member 2.

The free end of the supporting member 2 facing away from the supporting box 1 and the crane undercarriage comprises a support foot 3 which can be moved in the vertical direction V and which comprises a support disc and a piston rod of a hydraulic cylinder 17 which is linked to it in a joint.

When the supporting device is not exposed to a load, as shown in FIG. 1, it is possible for the hydraulic cylinder (not shown) to move the supporting member 2 relative to the supporting box 1 in the shifting direction T, wherein the supporting member 2 rests via its support bearing 12, which is embodied as a sliding element, and via a support bearing 8 of the supporting box 1, which comprises at least one rolling element 7, and slides or rolls off on the inner surface of the supporting box 1 via the bearings 12 and/or 8. The center of gravity S of the supporting member 2 is located beyond the support bearing 8 and/or outside the supporting box 1, generating a clockwise tilting torque, such that the contact portions 5 and 6 are kept spaced apart.

As soon as the supporting member 2 has been extended a desired length out of the supporting box 1 (the supporting member on the left-hand side (not shown) can be extended out of the supporting box 1 by any other length), the support foot 3 is extended downwards in the vertical direction by means of the hydraulic cylinder 17 in order to support the mobile crane. The contact force generated when it contacts the ground rotates and/or tilts the supporting member 2 anti-clockwise about the axis A relative to the supporting box 1 in the region of the support bearings 8 and 10. The supporting member 2 is then supported on the supporting box 1 via the support bearing 10, wherein the contact surfaces 6 and 5 arranged on the outer surface 14 of the supporting member 2 and the inner surface 13 of the supporting box 1 are moved into abutment. In the example shown, the contact surfaces 5, 6 are embodied as corresponding toothed profiles and interlock in a positive fit. In order to enable the contact surface 6 to engage over the entire range of movement of the supporting member 2, the contact surface 5 extends over the length necessary for this purpose in the interior of the supporting box 1. Due to the positive-fit engagement between the contact surfaces 5 and 6, it is no longer possible for the supporting member 2 to move in the direction of movement T.

As soon as the support foot 3 is raised upwards in the vertical direction again by means of the hydraulic cylinder 17 after the crane has been used, the supporting device is relieved of the load. Due to the location of the center of gravity S and due to the biasing force which the spring 16 exerts on the telescopic box 1 via the sliding block 15, a clockwise rotational movement about the axis A is in turn generated in the region of the support bearings 8 and 10, the contact portions 5 and 6 are separated from each other again, and the state shown in FIG. 1 is assumed. When the supporting device is not exposed to a load, it is again possible for the supporting member 2 to move.

1-10. (canceled)

11. A mobile crane supporting device, comprising:
a first support segment configured to be fastened to the undercarriage of the mobile crane;
a second support segment configured to be moved within and relative to the first support segment and which comprises a support foot configured to be moved in a vertical direction; and
a fixing device comprising contact portions which are respectively assigned to the first support segment and the second support segment and are configured to be moved into abutment with each other in order to prevent a travelling movement of the first support segment in any relative position between the first support segment and the second support segment,
wherein the second support segment is configured to rotate within and relative to the first support segment about an axis extending in a horizontal direction and transversely with respect to the travelling movement to selectively move the contact portions into abutment with each other or separate them from each other.

12. The mobile crane supporting device according to claim 11, wherein an end region of the first support segment facing the support foot comprises:
a lower support bearing which comprises at least one rolling element and via which the second support segment is configured to be supported on the first support segment while moving, and/or
an upper support bearing which comprises at least one pressing element and via which the second support segment is configured to be supported on the first support segment while rotating.

13. The mobile crane supporting device according to claim 12, wherein:
an end region of the second support segment facing away from the support foot comprises an upper support bearing which comprises at least one pressing element and via which the second support segment is configured to be supported on the first support segment while moving, and/or
the second support segment is embodied such that its center of gravity is always arranged beyond the lower support bearing of the first support segment and outside the first support segment.

14. The mobile crane supporting device according to claim 11, wherein the respective contact portions are arranged on an inner wall of the first support segment and an outer wall of the second support segment.

15. The mobile crane supporting device according to claim 11, wherein the respective contact portions interlock in a positive fit, wherein at least one of the contact portions exhibits a toothed profile.

16. The mobile crane supporting device according to claim 11, wherein the fixing device comprises a release device which is biased as soon as the contact portions are moved into abutment with each other and which, when biased, is inclined to separate the contact portions from each other again, wherein the release device comprises an elastic spring.

17. The mobile crane supporting device according to claim 11, wherein the travelling movement of the second support segment relative to the first support segment is generated by a hydraulic cylinder or a mechanical drive.

18. The mobile crane supporting device according to claim 11, wherein the support foot comprises a hydraulic supporting cylinder.

19. The mobile crane supporting device according to claim 11, wherein the first support segment is formed by a supporting box comprising supporting members which is movable on both sides of the supporting box and which respectively form a second support segment.

20. A mobile crane comprising a supporting device according to claim 11.
